(19) United States
(12) Patent Application Publication
(10) Pub. No.: US 2011/0049307 A1
(43) Pub. Date: Mar. 3, 2011

(54) VTOL VEHICLE WITH OFFSET ENGINE

(76) Inventor: Raphael Yoeli, Tel-Aviv (IL)

(21) Appl. No.: 12/989,533

(22) PCT Filed: Jun. 3, 2009
(86) PCT No.: PCT/IB09/52346

§ 371 Date: Nov. 16, 2010

Related U.S. Application Data
(60) Provisional application No. 61/129,068, filed on Jun. 3, 2008.

(51) Int. Cl. B64C 29/00

(52) U.S. Cl. 244/23 A

(57) ABSTRACT

A ducted air flow vehicle includes a fuselage having a longitudinal axis, supporting forward and aft air flow ducts having respective lift fans arranged to force surrounding air into said ducts through inlets at upper ends of said ducts and out of said ducts through outlets at lower ends of said ducts, thereby creating a lift force. A single engine is located on one side of said longitudinal axis, and is operatively configured to power the lift fans. A payload bay is located in a central area of said fuselage, between the forward and aft ducts, spanning the longitudinal axis.

### FIELD AND BACKGROUND OF THE INVENTION

The present application relates to VTOL vehicles with multi-function capabilities and, specifically to ducted fan arrangements that facilitate the flow of air during hover as well as forward flight of such vehicles, and the operation and behavior of these vehicles with particular attention to engine and payload placement.

VTOL vehicles rely on direct thrust from propellers or rotors, directed downwardly, for obtaining lift necessary to support the vehicle in the air. Many different types of VTOL vehicles have been proposed where the weight of the vehicle in hover is carried directly by rotors or propellers, with the axis of rotation perpendicular to the ground. One well known vehicle of this type is the conventional helicopter which includes a large rotor mounted above the vehicle fuselage. Other types of vehicles rely on a multitude of propellers that are either exposed (e.g., unducted fans), or installed inside circular cavities, shrouds, ducts or other types of nacelle (e.g., ducted fans), where the flow of air takes place inside ducts. Some VTOL vehicles (such as the V-22) use propellers having their axes of rotation fully rotatable (up to 90 degrees or so) with respect to the body of the vehicle; these vehicles normally have the propeller axis perpendicular to the ground for vertical takeoff and landing, and then tilt the propeller axis forward for normal flight. Other vehicles use propellers having nearly horizontal axes, but include aerodynamic deflectors installed behind the propeller which deflect all or part of the flow downwardly to create direct upward lift.

A number of VTOL vehicles have been proposed in the past where two or four propellers, usually mounted inside ducts (i.e., ducted fans), were placed forwardly of, and rearwardly of, the main payload of the vehicle. One typical example is the Piasecki VZ-8 ‘Flying Jeep’ which had two large ducts, with the pilots located to the sides of the vehicle, in the central area between the ducts. A similar configuration was used on the Chrysler VZ-6 and on the CityHawk flying car. Also the Bensen ‘Flying Bench’ uses a similar arrangement. The Curtiss Wright VZ-7 and the Moller Skycar use four, instead of two, thrusters where two are located on each side (forward and rear) of the pilots and the payload, the latter being of fixed nature at the center of the vehicle, close to the vehicle's center of gravity.

Typically, the lift fans and propulsion units or engines of VTOL vehicles have been arranged symmetrically to insure that the center-of-gravity (COG) of the vehicle is substantially centered on the longitudinal axis of the vehicle. For example, with a single propulsion unit mounted along the longitudinal axis of the vehicle, two compartments are typically provided, one on either side of the engine. In this arrangement, one of the compartments is typically the pilot's cockpit and the other is used as a payload bay. In order to gain payload space, it is necessary to relocate the engine to one side of the axis. This arrangement, however, causes COG imbalance issues which can affect flight characteristics. There remains a need for an arrangement in a VTOL vehicle that maximizes payload capability without unduly compromising the vehicle's flight characteristics.

### BRIEF SUMMARY OF THE INVENTION

The present invention relates to a single engine VTOL vehicle with forward and aft fan ducts located along the longitudinal axis of the vehicle fuselage, and optionally equipped also with a pair of thrusters or pusher fans located at the rearward end of the vehicle, on either side of the longitudinal axis. In one arrangement, a single propulsion unit or engine drives the lift fans, while the thrusters or pusher fans are powered separately, for example, by electric motors. Alternatively, the thrusters or pusher fans could be driven by the engine through a suitable transmission. Examples of ducted fan arrangements may be found in commonly owned U.S. Pat. Nos. 6,464,166; 6,568,630; 6,817,570; 6,883,748; 7,246,769; 7,275,712; or Publication No. 2008/0054121. In an exemplary but nonlimiting implementation of the disclosed technology, the single engine is located asymmetrically with respect to the longitudinal axis of the vehicle, thus increasing the available space for a payload bay. While the engine placement creates some COG imbalance, that imbalance can be at least partially if not completely compensated for by placement of cargo in the payload bay. In other words, the payload or cargo may be asymmetrically placed in an opposite sense relative to the engine placement to minimize any COG imbalance.

In one exemplary embodiment, the single engine may be located centrally between the forward and aft ducts, but to one side of the longitudinal axis, with an uninterrupted payload bay occupying the remaining central area of the fuselage, spanning an area from an access hatch or door on the side of the fuselage opposite the engine, across the longitudinal axis to an internal partition adjacent the engine. In this embodiment, the vehicle could be unmanned, or a pilot compartment could be located on the side of the fuselage opposite the engine, with the payload area in between.

In another exemplary embodiment, the single engine is located rearwardly and to one side of the longitudinal axis, above or below the propeller of the aft lift fan. This arrangement frees up the entire center area for use as a payload bay. If piloted, the pilot compartment may be located in the center area but on the opposite side of the longitudinal axis.

In the exemplary embodiments, the expanded payload bay area, being uninterrupted by engines or any other aircraft related items, may be used in various applications. For example, the payload bay may be sufficiently large to accommodate standard cargo containers. In another application, the VTOL vehicle may be configured as an ambulance, with the payload bay set up to receive one or more wounded, sick and/or medical personnel. It will be appreciated that the term “payload bay” is thus considered generic to any number of applications where the bay is used to carry cargo of various kinds, passengers, or vehicle systems equipment and the like.

In a variation of the above, a pair of engines may be located in opposite sides of the longitudinal axis of the vehicle, with the payload bay located in the center area of the fuselage.

It is another feature of the invention to incorporate an automatically deployable emergency parachute to enable the VTOL vehicle to make a soft landing in the event of engine failure. This is especially advantageous in the exemplary embodiments described herein where a single propulsion unit or engine is used to power the lift fans.

The offset engine feature described herein also requires modified drive arrangements which are described further herein.

Accordingly, in one aspect, the present invention relates to a ducted air flow vehicle comprising: a fuselage having a longitudinal axis, supporting forward and aft air flow ducts having respective lift fans arranged to force surrounding air into and out of said ducts thereby creating a lift force; a single engine located on one side of said longitudinal axis, said single engine operatively configured to power said lift fans; and a payload bay located in a central area of said fuselage, between said forward and aft ducts, spanning said longitudinal axis.

In another aspect, the invention relates to a ducted air flow vehicle comprising: a fuselage having a longitudinal axis, supporting forward and aft air flow ducts having respective lift fans arranged to force surrounding air into and out of the ducts thereby creating a lift force; a single engine located on one side of the longitudinal axis adjacent the aft lift fan, the single engine operatively configured to power the forward and aft lift fans; a payload bay located in a central area of the fuselage, between the forward and aft ducts, spanning the longitudinal axis, and wherein a greater volumetric portion of the payload bay is located on an opposite side of the longitudinal axis; and a pilot cabin located in the central area on the opposite side of the longitudinal axis.

In still another aspect, the invention relates to a ducted air flow vehicle comprising: a fuselage having a longitudinal axis, supporting forward and aft air flow ducts having respective lift fans arranged to force surrounding air into and out of the ducts thereby creating a lift force; a pair of engines located on opposite sides of the longitudinal axis, respectively, the engines operatively configured to power the lift fans; and a payload bay located in a central area of the fuselage, between the forward and aft ducts and between the pair of engines.

The invention will now be described in detail in connection with the drawings identified below.

### BRIEF DESCRIPTION OF THE DRAWINGS

FIG. 1 is a side elevation of a VTOL vehicle in accordance with an exemplary but nonlimiting embodiment of the invention;

FIG. 2 is a plan view of the VTOL vehicle in FIG. 1 illustrating an engine placement in accordance with one embodiment of the invention;

FIG. 3 is a plan view similar to FIG. 2 but illustrating an engine placement in accordance with another embodiment of the invention;

FIG. 4 is a plan view similar to FIG. 3, but with a pilot compartment added;

FIG. 5 is a plan view similar to FIG. 4, but showing the payload bay in an ambulance application;

FIG. 6 is a plan view similar to FIG. 2 but showing a standard cargo container in the payload bay;

FIGS. 7-9 are schematic views of drive arrangements suitable for use with an engine location as shown in FIGS. 4 and 5;

FIG. 10 is a partial schematic of an engine/gear box connection when the engine is in the plane of the drive shafts;

FIG. 11 is a plan view of a VTOL vehicle similar to that shown in FIG. 6 but with an alternative payload configuration; and

FIG. 12 is a plan view of a VTOL vehicle similar to that shown in FIG. 6 but wherein a second engine is added to increase the lifting capability of the vehicle.

### DETAILED DESCRIPTION OF THE DRAWINGS

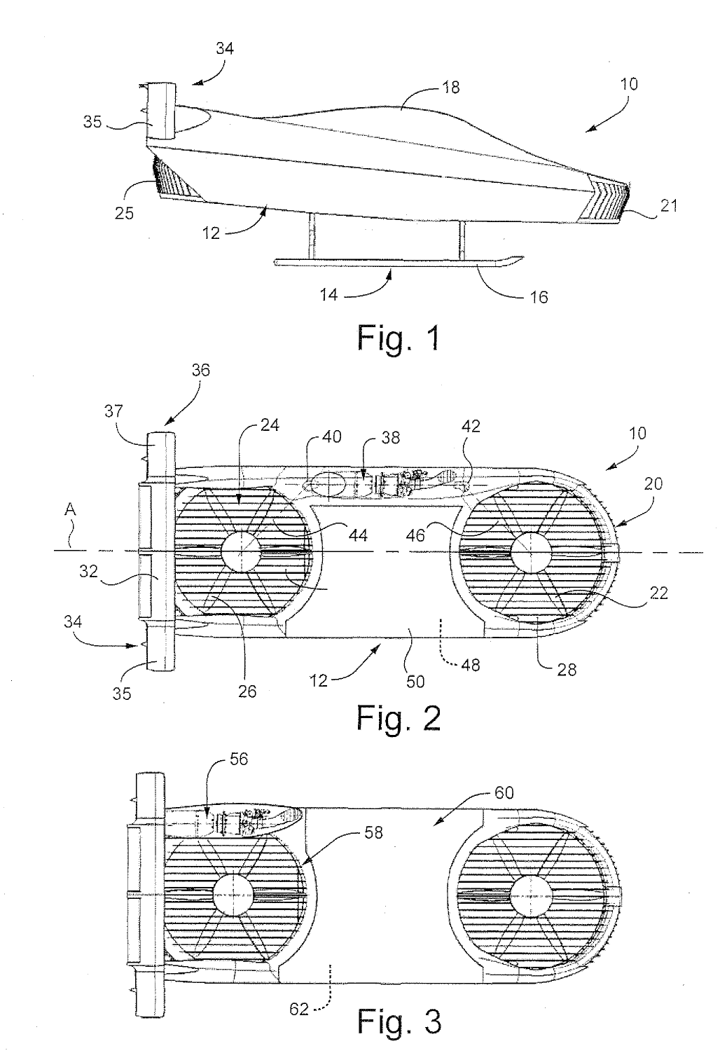

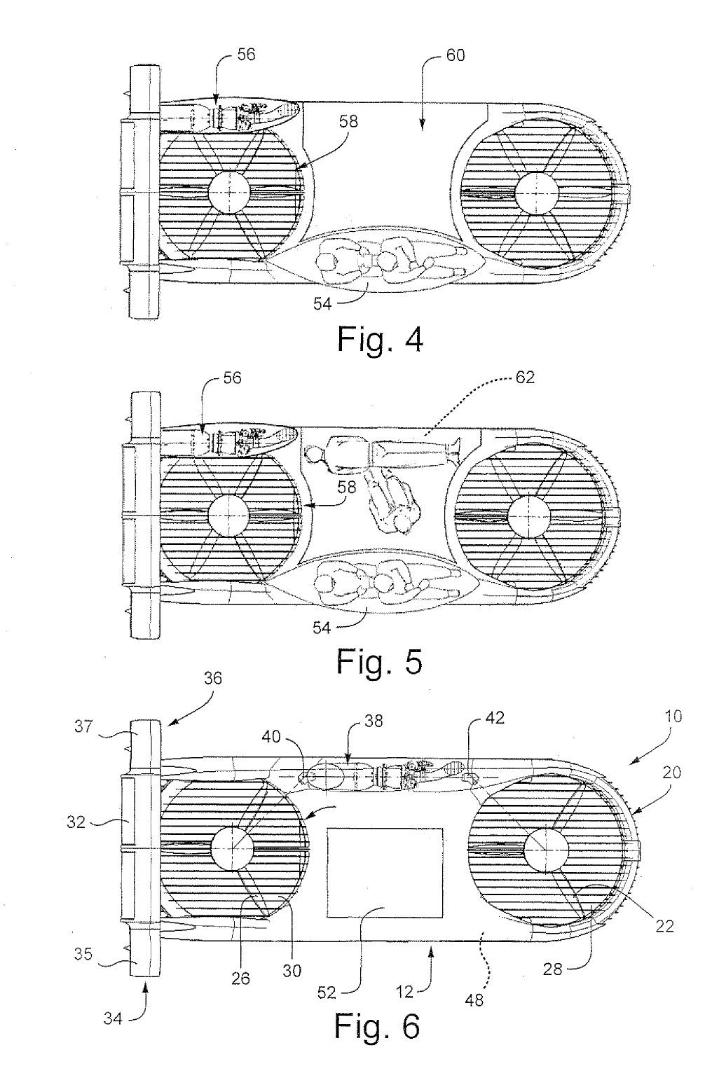

With reference initially to FIGS. 1 and 2, a ducted fan vehicle, e.g. a VTOL vehicle 10 includes a vehicle body or fuselage 12, a landing gear assembly 14 which may be in the form of a pair of skids 16 (one shown), or one or two sets of wheels (not shown). An aerodynamically shaped surface portion 18 may form part of a pilot or passenger compartment, and may be located along one side of the fuselage, as best seen in FIGS. 4 and 5. There may also be a substantially identical surface portion on the opposite side of the fuselage for some applications of the VTOL vehicle. Alternatively, the surface having the shape shown as 18 may also span the entire width of the fuselage and be substantially uniform across its span.

As best seen in FIG. 2, the vehicle body or fuselage supports a forward air flow duct 20 which houses a first lift fan propeller 22, and an aft air flow duct 24 which houses a second lift fan propeller 26 (lift fan propellers 22 and 26 may also be referred to herein simply as “lift fans”). In one example, a plurality of adjustable control vanes 28 extend across the upper or inlet side of the forward duct 20, and a similar plurality of control vanes 30 extend across the inlet side of the aft duct 24. Referring back to FIG. 1, adjustable openings 21 and 25 may be provided in the front portion of the forward duct 20 and the rear portion of the aft duct 24, respectively, enabling variation of airflows through the ducts. A horizontal stabilizer 32 extends across the rear of the vehicle, above and behind the aft duct. A pair of thrusters or pusher fans 34, 36 are located at opposite ends of the stabilizer and provide forward or rearward thrust forces for forward or rearward flight of the vehicle. These fans are enclosed and supported by ring-shaped structural members 35, 37, respectively, that may also be aerodynamically shaped so as to function as air ducts, and that may also provide support for horizontal stabilizer 32.

Details of the ducts, lift fans and thrust fans, and the manner in which the fans are operated and the control vanes adjusted to control vehicle movements in hover and in forward flight are described in the above-identified patents, and need not be discussed in any greater detail here. In this regard, however, the invention is applicable to various VTOL vehicle configurations, including vehicles which do not employ the optional stabilizer or thrusters as shown herein.

With reference to the exemplary but non-limiting embodiment shown in FIG. 2, the vehicle's single engine 38 is located to one side of the vehicle longitudinal axis A, but substantially centrally between the forward and aft ducts 20, 24, respectively. Engine output shafts may be connected to gear boxes 40, 42 that enable a forty five degree (or other) mechanical coupling to a pair of drive shafts 44, 46 (indicated by dotted lines) that are in turn operatively connected to the rotors of the lift fan propellers 22 and 26. This arrangement permits the incorporation of an enlarged and uninterrupted payload bay 48 that may be accessed by a pivoting door 50 or the like on the side of the fuselage opposite the engine 38, or via a door or hatch on the underside of the vehicle or both. Note that while the payload bay spans the longitudinal axis A, the majority of the volumetric space of the payload bay is located on the side of the longitudinal axis A opposite the engine 38. As indicated above, location of the engine 38 on one side of the longitudinal axis A creates an imbalance in the COG of the vehicle. This imbalance can be largely compensated for by placement of, for example, a cargo container 52 within the payload bay 48, arranged in a position that is asymmetric to the longitudinal axis A but that substantially balances the weight of the engine 38, as shown in FIG. 6. Note that while the location of the engine affects the vehicle COG, it does not necessarily impact on the aerodynamics of the vehicle. As already mentioned, the aerodynamically shaped center portion 18 of the vehicle may be uniformly shaped across the entire width of the vehicle regardless of the location of the engine, payload bay and/or optional pilot cabin. The expanded payload bay may be of a size that enables the VTOL vehicle to carry standard-size cargo containers, such as, for example, the U.S. Navy JMIC container. The standard open dimensions for this container are 51.75″×43.75″×43″ but other versions of the container with different dimensions are available. Of course, rather than a single container, multiple separate packages may be distributed within the payload bay 48.

Note that as shown in FIGS. 2 and 6, the VTOL vehicle is shown as an unmanned vehicle. If, however, the vehicle is to be piloted, a pilot compartment or cabin 54 may be incorporated into the vehicle body, preferably on the opposite side of the longitudinal axis as shown in FIG. 4, for example, and as described in further detail below.

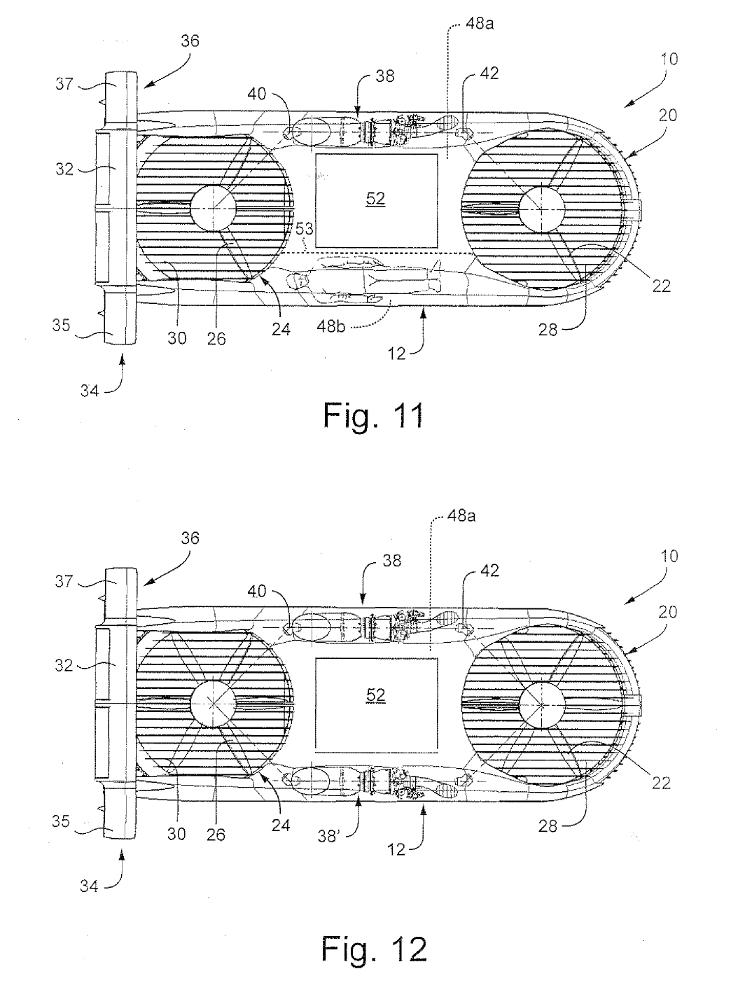

With reference now to FIG. 11, in the event the uninterrupted payload bay 48 is not employed to 100% of its capacity, it is also possible to move the container 52 laterally toward the engine 38, creating additional payload space on the opposite side of the container. This additional space may be utilized to create separate payload compartments 48A, 48B (for example, separated by a removable partition or separator 53). The payload compartment 48B may be used to carry, for example, a wounded soldier as shown in FIG. 11, but, of course, it could be used to carry other cargo such as food, ammunition, supplies, or other equipment. In this arrangement, the pilot cabin, if incorporated, would be located above compartment 48B.

On the other hand, the additional space made available by utilizing only the center compartment 48A permits the addition of a second engine 38′ (in the area occupied by compartment 48B in FIG. 11) to enhance the lifting capability of the vehicle, as shown in FIG. 12. Thus, a pair of engines may be located on opposite dies of the longitudinal axis, with the payload bay located between the engines. Here, the pilot cabin would be located between the engines or above one of the engines.

In both FIGS. 11 and 12, access to the center bay area 48A may be via a door or hatch (not shown) on the underside of the vehicle, while access to payload area 48B (or to the engines 38 and or 38′), may be from doors or hatches on the sides or underside of the vehicle.

FIGS. 3, 4 and 5 illustrate another exemplary but non-limiting embodiment of the invention, showing a single engine 56 located rearwardly of the center area of the fuselage, substantially adjacent and slightly above the aft duct 58. This arrangement frees up substantially the entire center area 60 of the fuselage for use as a payload bay 62, if unmanned as shown in FIG. 3. In the piloted configuration shown in FIGS. 4 and 5, the pilot cabin or compartment 54 (FIGS. 4, 5) is located on the side of the longitudinal axis A opposite the engine 56, such that the payload bay is otherwise similar in size and capacity to the payload bay 48 in FIG. 2. FIG. 5 illustrates how a payload bay 62 might be used in an application where the VTOL vehicle is configured for use as an ambulance, with room for one or more wounded or sick persons and/or medical personnel. It will be understood, of course, that the payload bay and the pilot cabin or compartment may be configured for many different applications.

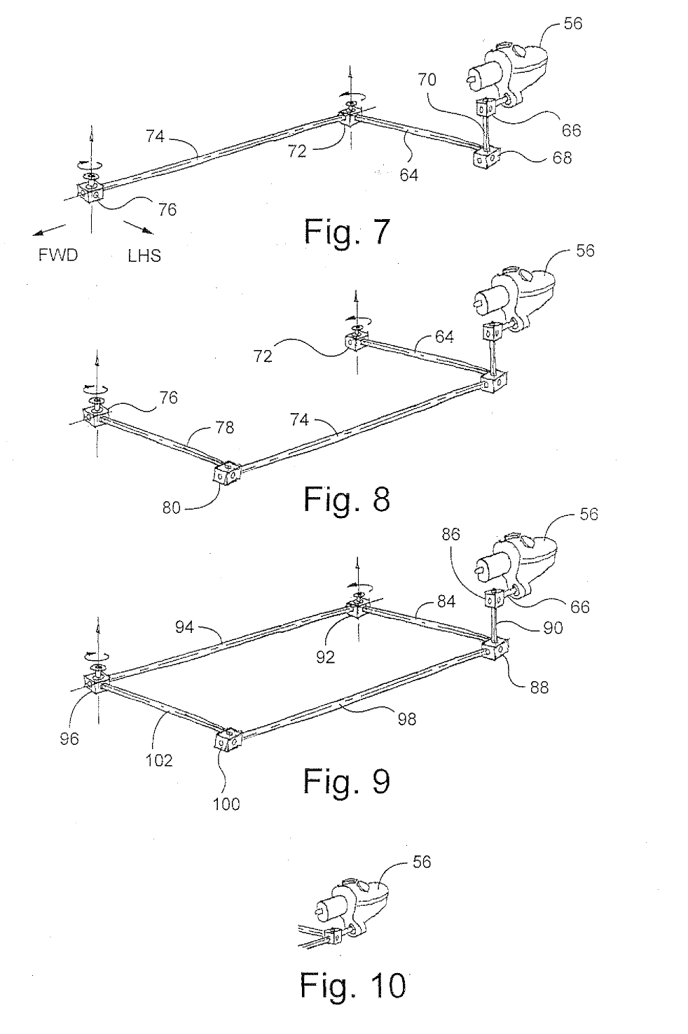

With the engine location as shown in FIGS. 3-5, various drive arrangements are possible. In FIG. 7, the engine 56 connects to a transverse drive shaft 64 via gearboxes 66, 68 and shaft 70. The transverse shaft 64 is connected to the rotor of the aft lift fan propeller 22 via a third gearbox 72. Gearbox 72 is in turn connected to a longitudinal drive shaft 74 that is connected to the rotor of the forward lift fan propeller 26 via a fourth gearbox 76.

A similar arrangement is shown in FIG. 8 but in this arrangement, the longitudinal drive shaft 74′ is located on the same side of the longitudinal axis A as the engine 56, requiring a second transverse drive shaft 78 and a fifth gearbox 80.

FIG. 9 illustrates a double or redundant load path which insures torque transmission upon failure of any shaft in the drive train other than the shaft closest to the engine. Specifically, the output shaft 82 of the engine 56 connects to a first transverse drive shaft 84 via gearboxes 86, 88 and shaft 90. The first transverse shaft 84 is connected to the rotor of the aft lift fan propeller 22 via a third gearbox 92. A first longitudinal drive shaft 94 extends between the gearbox 92 and the rotor of the forward lift fan propeller 26 via gearbox 96. At the same time, a second longitudinal drive shaft 98 extends between gearbox 88 and gearbox 100, which is in turn connected to the gearbox 96 via a second transverse shaft 102. With this arrangement, failure of any shaft other than shaft 90 will result in driving torque being applied to both the forward and aft lift fan propellers. It should be mentioned that in the arrangement described in FIG. 7, gearbox 66, shaft 70 and gearbox 68 could optionally be combined in one elongated gearbox providing the same functionality as the three units acting separately, with the same arrangement; possible for FIGS. 8 and 9.

FIG. 10 illustrates a variation where the engine 56 is in essentially the same plane as the drive shaft assembly, eliminating one gearbox and the need for the vertical connector shafts 70 (FIG. 7) and 90 (FIG. 9), and thus providing a more compact and lower profile installation.

In light of the single-engine configuration of the VTOL vehicle as described herein, it is another feature of the invention to incorporate an automatically deployable emergency parachute into the VTOL vehicle. The emerging parachute will deploy in the event of engine failure, thus enabling a relatively soft landing for the vehicle. The incorporation of an emergency chute is more fully described in commonly owned Publication No. 2008/005412.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A ducted air flow vehicle comprising:
a fuselage having a longitudinal axis, supporting forward and aft air flow ducts having respective lift fans arranged to force surrounding air into and out of said ducts thereby creating a lift force;
a single engine located on one side of said longitudinal axis, said single engine operatively configured to power said lift fans; and
a payload bay located in a central area of said fuselage, between said forward and aft ducts, spanning said longitudinal axis.

2. The vehicle of claim 1 comprising a pilot cabin located in said central area on said opposite side of said longitudinal axis.

3. The vehicle of claim 1 wherein said single engine is located between said forward and aft ducts.

4. The vehicle of claim 1 wherein said single engine is located adjacent said aft lift fan.

5. The vehicle of claim 1 wherein said payload bay is accessible at least on said opposite side of said longitudinal axis.

6. The vehicle of claim 1 wherein said vehicle further comprises a pair of thruster fans located behind and above said aft lift fan.

7. The vehicle of claim 6 wherein said thruster fans are powered separately from said forward and aft lift fans.

8. The vehicle of claim one wherein a plurality of control vanes extend across said inlets, substantially parallel to said longitudinal axis.

9. The vehicle of claim 1 wherein said motor is connected directly to rotors of said forward and aft lift fans by a pair of respective drive shafts oriented at acute angles to said longitudinal axis.

10. The vehicle of claim 4 wherein said engine is connected to said aft lift fan by a transverse drive shaft and to said forward lift fan by a longitudinal drive shaft connected to said transverse drive shaft, said longitudinal drive shaft extending along an opposite side of said longitudinal axis.

11. The vehicle of claim 4 wherein said engine is connected to said aft lift fan by a transverse drive shaft and to said forward lift fan by a longitudinal drive shaft connected to said transverse drive shaft, said longitudinal drive shaft extending along said one side of said longitudinal axis.

12. The vehicle of claim 4 wherein the engine is connected to the forward and aft lift fans by plural redundant drive shafts configured to enable driving torque to both the forward and aft lift fan upon failure of at least some of said plurality of drive shafts.

13. The vehicle of claim 1 wherein an output shaft of the engine is connected to a drive train extending between said engine and said forward and aft lift fans, said output shaft and said drive train lying in a common plane.

14. The vehicle of claim 1 wherein a greater volumetric portion of said payload bay is located on an opposite side of said longitudinal axis.

15. The vehicle of claim 1 comprising an emerging parachute automatically deployable upon failure of said single engine.

16. The vehicle of claim 1 wherein said payload bay is divided into two separated accessible compartments.

17. A ducted air flow vehicle comprising:
a fuselage having a longitudinal axis, supporting forward and aft air flow ducts having respective lift fans arranged to force surrounding air into and out of said ducts thereby creating a lift force;
a single engine located on one side of said longitudinal axis adjacent said aft lift fan, said single engine operatively configured to power said forward and aft lift fans;
a payload bay located in a central area of said fuselage, between said forward and aft ducts, spanning said longitudinal axis, and wherein a greater volumetric portion of said payload bay is located on an opposite side of said longitudinal axis; and
a pilot cabin located in said central area on said opposite side of said longitudinal axis.

18. The vehicle of claim 17 wherein said vehicle further comprises a pair of thruster fans located behind and above said aft lift fan.

19. The vehicle of claim 17 wherein said thruster fans are powered separately from said forward and aft lift fans.

20. The vehicle of claim 17 wherein the engine is connected to the forward and aft lift fans by plural redundant drive shafts configured to enable driving torque to both the forward and aft lift fan upon failure of at least some of said plurality of drive shafts.

21. The vehicle of claim 17 comprising an emergency parachute automatically deployable upon failure of said single engine.

22. A ducted air flow vehicle comprising:
a fuselage having a longitudinal axis, supporting forward and aft air flow ducts having respective lift fans arranged to force surrounding air into and out of said ducts thereby creating a lift force;
a pair of engines located on opposite sides of said longitudinal axis, respectively, said engines operatively configured to power said lift fans; and
a payload bay located in a central area of said fuselage, between said forward and aft ducts, and between said pair of engines.

23. The ducted air flow vehicle of claim 22 comprising an access hatch to said payload bay on an underside of said fuselage.
